(19) United States
(12) Patent Application Publication
(10) Pub. No.: US 2009/0073479 A1
(43) Pub. Date: Mar. 19, 2009

(54) IMAGE SCANNING APPARATUS

(75) Inventor: Naoya Murakami, Yokohama-shi (JP)

Correspondence Address: AMIN, TUROCY & CALVIN, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/207,992

(22) Filed: Sep. 10, 2008

Related U.S. Application Data
(60) Provisional application No. 60/972,483, filed on Sep. 14, 2007.

(51) Int. Cl. H04N 1/04; G06F 3/12

(52) U.S. Cl. 358/1.13; 358/474

(57) ABSTRACT

A digital copying apparatus includes a scanner, a monochrome converting unit, an out-of-original detecting unit, a deleting unit, and a printer. The scanner scans an image of an original as color image data. The monochrome converting unit converts the color image data scanned by the scanner into monochrome image data. The out-of-original detecting unit detects an out-of-original area in the monochrome image data provided by the monochrome converting unit. The deleting unit deletes an image of the area determined as out-of-original by the out-of-original detecting unit, in the color image data scanned by the scanner. The printer prints the image from which the image of the out-of-original area is deleted by the deleting unit, onto a recording medium.

### CROSS-REFERENCE TO RELATED APPLICATION

This application claims the benefit of U.S. Provisional Application No. 60/972,483, filed Sep. 14, 2007.

### TECHNICAL FIELD

The present invention relates to an image scanning apparatus, for example a scanner that scans an original image, and a copying apparatus that prints an image scanned by an image scanning apparatus onto a recording medium.

### BACKGROUND

Conventionally, a digital multifunction peripheral has the function of an image scanning apparatus or copying apparatus. There is a digital multifunction peripheral having the function of deleting an out-of-original unnecessary area (black part) with respect to image data of an original scanned by a scanner with a platen cover opened. For example, U.S. Pat. No. 5,629,777 discloses a technique of deleting an out-of-original area from image data of an original scanned with a platen cover opened in a monochrome digital multifunction peripheral. In the technique disclosed in U.S. Pat. No. 5,629,777, it is determined whether the density value of each pixel in monochrome image data scanned by a scanner is likely to be the density value of an out-of-original pixel or not. In the technique disclosed in U.S. Pat. No. 5,629,777, an out-of-original area in the scanned image data is detected in accordance with the result of determination as described above, and the image of the area determined as out-of-original is deleted.

However, in the technique disclosed in U.S. Pat. No. 5,629,777, the density value of each pixel in the scanned image of the original is simply compared with a threshold value. Therefore, in the technique disclosed in U.S. Pat. No. 5,629,777, an area in the image data within the original where pixels having large density values are concentrated may be mistakenly determined as an out-of-original area. Moreover, recently, color digital multifunction peripheral (color MFPs) are becoming increasingly popular. In a color digital multifunction peripheral, an original image is scanned as a color image. In such a color digital multifunction peripheral, it is necessary to divide color image data as a scanned image of the original into an out-of-original area and other areas.

### SUMMARY

An image scanning apparatus according to an aspect of the invention includes: a scanner that scans an image of an original as color image data; a converting unit configured to convert the color image data scanned by the scanner into monochrome image data; a detecting unit configured to detect an out-of-original area in the monochrome image data provided by the converting unit; and a deleting unit configured to delete an image of the area determined as out-of-original by the detecting unit, in the color image data scanned by the scanner.

A copying apparatus according to another aspect of the invention includes: a scanner that scans an image of an original as color image data; a converting unit configured to convert the color image data scanned by the scanner into monochrome image data; a detecting unit configured to detect an out-of-original area in the monochrome image data provided by the converting unit; a deleting unit configured to delete an image of the area determined as out-of-original by the detecting unit, in the color image data scanned by the scanner; and a printer that prints the image from which the image of the out-of-original area is deleted by the deleting unit, onto a recording medium.

An image scanning method according to still another aspect of the invention includes: scanning an image of an original as color image data; converting the scanned color image data into monochrome image data; detecting an out-of-original area in the monochrome image data provided by the conversion; and deleting an image of the area determined as out-of-original by the detection, in the scanned color image data.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing an exemplary configuration of a digital multifunction peripheral.

FIG. 2A shows an exemplary image scanned with a platen cover opened.

FIG. 2B shows an image obtained by deleting an out-of-original black image from the scanned image of FIG. 2A.

FIG. 3A shows an exemplary image scanned with a platen cover opened.

FIG. 3B shows an image obtained by simply deleting pixels having a specified density value or higher from the scanned image of FIG. 3A.

FIG. 4 is a view for explaining a flow of signals in an out-of-original deleting unit.

FIG. 5A is a view showing an exemplary histogram with respect to an out-of-original black image.

FIG. 5B is a view showing an exemplary histogram with respect to a pixel value obtained by converting each pixel in the out-of-original black image into monochrome.

FIG. 6A is a view showing an exemplary histogram with respect to a black image within an original.

FIG. 6B is a view showing an exemplary histogram with respect to a pixel value obtained by converting each pixel in the black image within an original into monochrome.

FIG. 7 is a flowchart for explaining a flow of copy processing including out-of-original deletion.

### DETAILED DESCRIPTION

Hereinafter, an embodiment will be described with reference to the drawings.

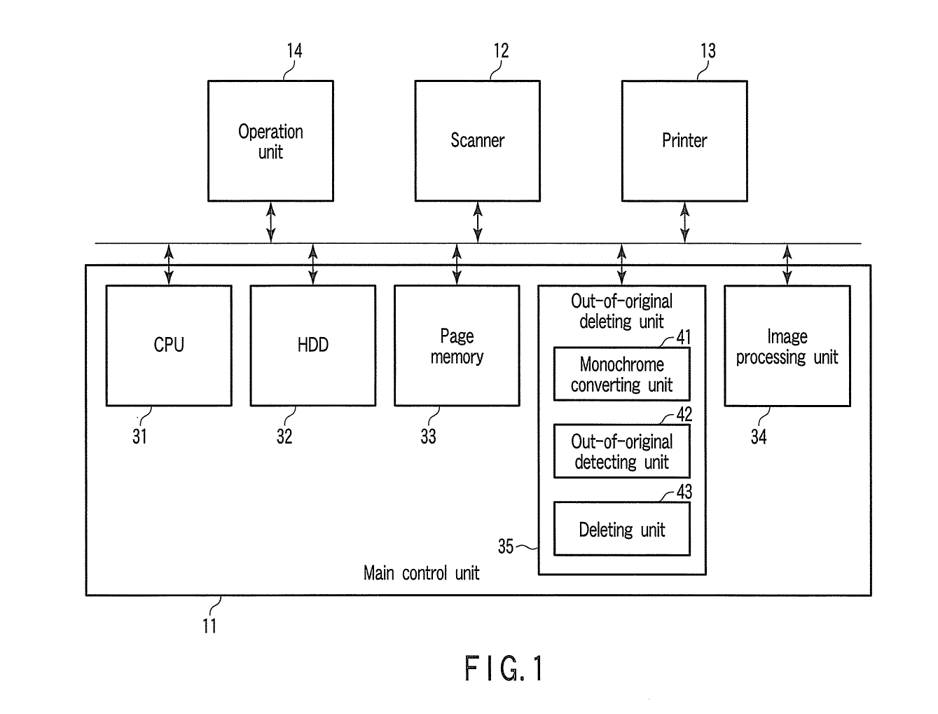

FIG. 1 is a block diagram showing an exemplary configuration of a digital multifunction peripheral 1.

The digital multifunction peripheral shown in FIG. 1 functions as an image scanning apparatus or copying apparatus. In the exemplary configuration shown in FIG. 1, the digital multifunction peripheral 1 has a main control unit 11, a scanner 12, a printer 13, and an operation unit 14.

The main control unit 11 controls the entire digital multifunction peripheral 1. For example, the main control unit 11 controls the operations of the scanner 12, the printer 13 or the operation unit 14. The main control unit 11 also has the function of processing an image, the function of saving an image and so on.

The scanner 12 optically scans an image on a recording medium (original) as color image data. The scanner 12 has a scanning unit for optically scanning an original image, a glass (platen glass) as an original setting board, and a cover (platen cover) that covers the original setting board.

The scanning unit is provided below the platen glass. The scanning unit converts an image of an original set on the platen glass into color image data. The scanning unit supplies the scanned color image data to the main control unit 11.

For example, the scanning unit has a driving mechanism, a CCD line sensor, and a signal processing unit (none of which is shown). The scanning unit is moved by the driving mechanism into the sub scanning direction below the platen glass. The scanning unit scans an image of an original on the platen glass by using the CCD line sensor while moving in the sub scanning direction. The CCD line sensor includes plural CCD sensors arrayed in the main scanning direction with respect to the original. The CCD line sensor converts reflected light from the original into an analog image signal. The signal processing unit converts the analog image signal scanned by the CCD line sensor into a digital image signal. In this embodiment, the scanner 12 scans an original image as color image data including red (R), green (G) and blue (B). That is, each pixel (the color of each pixel) of the image data scanned by the scanner 12 is expressed by an R density value, a G density value and a B density value.

The platen glass functions as an original setting board that holds an original to be a scanning target. The platen cover is configured to be opened and closed by a user. The platen cover, when closed, covers the entire platen glass. The platen cover also functions as a holding member for an original set on the platen glass.

A surface of the platen cover on the side of the platen glass (original) is formed, for example, in white. Therefore, when the platen cover is closed, the CCDs of the scanning unit acquire reflected light with a minimum density value (maximum luminance) from the out-of-original area. Thus, when the platen cover is closed, the CCDs of the scanning unit scan the out-of-original area as an image having a “minimum” density value (“maximum” luminance value). In short, when the platen cover is closed, the scanning unit scans the out-of-original area as white.

On the other hand, when the platen cover is opened, the CCDs of the scanning unit cannot acquire reflected light from the out-of-original area (reflected light from the original). Therefore, when the platen cover is opened, the scanning unit scans the out-of-original area on the platen glass as black. In short, when the platen cover is opened, the scanning unit scans the out-of-original area as a black image having a “maximum” density value (“minimum” luminance value).

The printer 13 forms image data supplied from the main control unit 11 onto an image forming target medium (copy sheet). As the printer 13, a printer having an arbitrary image forming system can be applied. For example, the printer 13 may be a laser printer or an inkjet printer.

The operation unit 14 has a display device and operation keys. For example, the operation unit 14 has a liquid crystal display device with a built-in touch panel, and hard keys such as ten keys.

The main control unit 11 has a CPU 31, an HDD 32, a page memory 33, an image processing unit 34, and an out-of-original deleting unit 35. The CPU 31 controls the entire digital multifunction peripheral 1. The CPU 31 executes programs stored in a program memory, not shown, thereby realizing various functions. For example, the CPU 31 controls the scanner 12 and the printer 13 in accordance with a copy control program, thereby realizing copy control.

The HDD (hard disk drive) 32 is a non-volatile memory. The HDD 32 saves image data. For example, the HDD 32 stores code data as compressed image data.

The page memory 33 is a memory for storing an image to be processed. For example, the page memory 33 stores at least color image data corresponding to one page. The page memory 33 is controlled by a page memory control unit, not shown. The image data on the page memory 33 is, for example, scanned image data taken in from the scanner 12 or print image data to be outputted to the printer 13.

The image processing unit 34 processes the scanned image data taken in from the scanner 12 or the print image data to be outputted to the printer 13.

For example, the image processing unit 34 has image processing functions such as shading correction, tone conversion, inter-line correction and compression, as image processing functions for the original image data scanned by the scanner 12. The image processing unit 34 saves the scanned image data processed as described above, to the page memory 33.

Shading correction is the processing to correct image data in accordance with unevenness of sensitivity of each photoelectric conversion element in the scanner 12 or luminous intensity distribution of a lamp (not shown) for illuminating the original. Tone conversion is the processing to convert the value of each pixel (for example, each signal value of R, G and B) constituting image data in accordance with a lookup table (LUT), not shown. Inter-line correction is the processing to correct a physical misalignment of each CCD sensor of R, G and B in the scanner. Compression is the processing to encode image data and save the encoded image data into the page memory 33.

The image processing unit 34 also has image processing functions such as expansion, color conversion, filtering, gamma correction and gradation processing, as image processing functions for the print image data to be printed by the printer 13. The image processing unit 34 performs the above image processing to the image data saved in the page memory 33 and thereby outputs the processed image data to the printer 13 as print image data.

Expansion is the processing to convert (expand) the encoded image data stored in the page memory 33 into non-compressed image data. Color conversion is the processing to convert image data into print image data. For example, by color conversion, color image data of R, G and B scanned by the scanner 12 is converted to color image data of cyan (C), magenta (M), yellow (Y) and black (K). Filtering is, for example, MTF correction of image data. Gamma correction is the processing to correct image data in accordance with the gamma characteristic of the printer 13. Gradation processing is screening of gamma-corrected image data.

The out-of-original deleting unit 35 deletes other areas than an original image in image data. The out-of-original deleting unit 35 carries out processing to delete the image of an out-of-original area from image data scanned by the scanner 12. As shown in FIG. 1, the out-of-original deleting unit 35 mainly includes a monochrome converting unit 41, an out-of-original detecting unit 42, and a deleting unit 43. The monochrome converting unit 41 converts color image data to monochrome image data. The out-of-original detecting unit 42 detects an out-of-original area from image data. The deleting unit 43 deletes the image data of the out-of-original area from the image data.

Next, out-of-original deletion at the out-of-original deleting unit 35 will be described in detail.

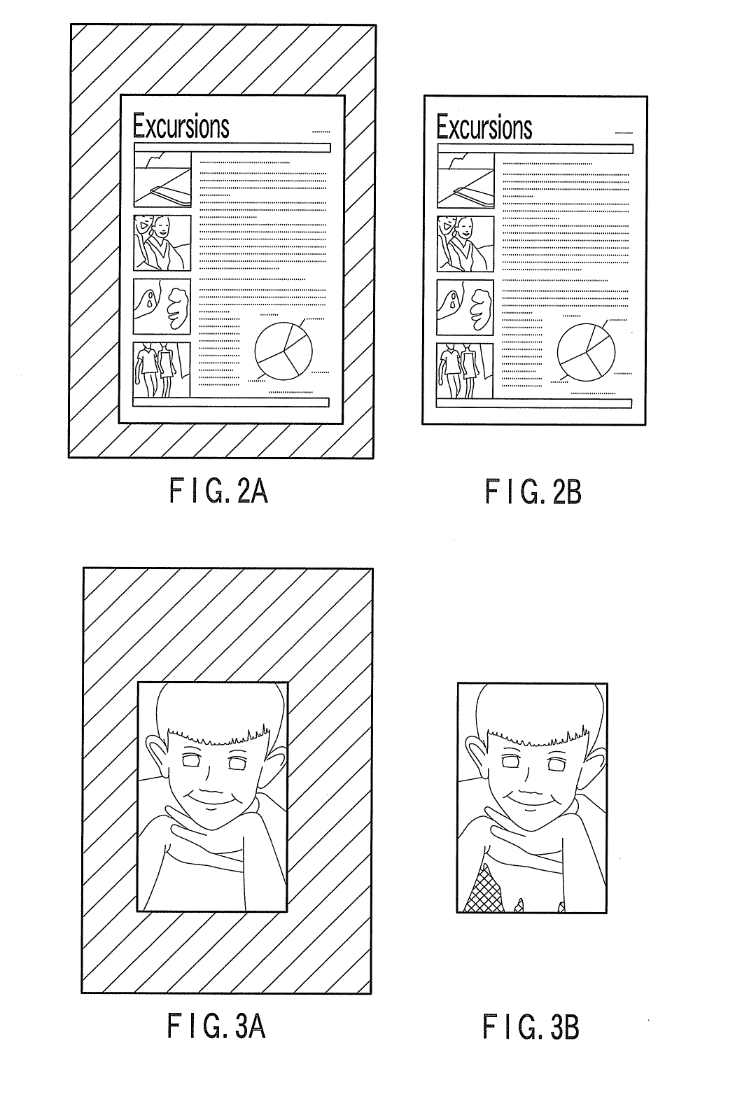

FIG. 2A is a view showing an exemplary image obtained by scanning an original set on the platen glass with the platen cover opened. FIG. 2B shows an image obtained by deleting an out-of-original black image from the scanned image shown in FIG. 2A. In the image shown in FIG. 2B, only the out-of-original black image is deleted. Converting an image as shown in FIG. 2A to an image as shown in FIG. 2B is the out-of-original deletion.

FIG. 3A, too, is a view showing an exemplary image obtained by scanning an original set on the platen glass with the platen cover opened. However, for the image shown in FIG. 3A, the original contains an area of dark color close to black. FIG. 3B shows an image obtained by deleting dark-colored pixels having a specified density value or higher, from the image data shown in FIG. 3A. In the image shown in FIG. 3B, the images of some areas in the original are deleted together with the out-of-original black image. If the image of a dark-colored area in the original and the out-of-original image cannot be separated, the images of some parts in the original can be deleted in the out-of-original deletion, as shown in FIG. 3B.

The out-of-original deleting unit 35 in this embodiment separates the image of a dark-colored area in the original and the out-of-original image highly accurately. The out-of-original deleting unit 35 takes, as a processing target, a color image scanned by the scanner 12 in which each pixel is expressed by an R, G or B value. When the RGB color image scanned by the scanner 12 is supplied, the out-of-original deleting unit 35 converts each pixel (color pixel) of the color image to monochrome by using the monochrome converting unit 41. For example, the monochrome converting unit 41 converts color pixels to monochrome in accordance with the following equation (A1).

BK value (monochrome-converted value)=α×(R signal)+β×(G signal)+γ×(B signal) (A1)

In the equation (A1), α, β and γ are coefficients that satisfy, for example, the following condition (B1).

0≦α, β, γ≦1 (B1)

As an example, it can be considered that the monochrome converting unit 41 calculates a monochrome value (BK) by using BK value=(R+G+B)/3. In this case, each of the coefficients α, β and γ is set to be “0.333 . . . ”.

However, it is preferable that the coefficients α, β and γ have values that enable easy separation of a black image of within the original (hereinafter referred to as an in-original black image) and a black image as an out-of-original image in the platen cover-opened state (hereinafter referred to as an out-of-original black image).

Since the out-of-original black image shows the state where reflected light from the original is not incident on the CCD sensors, all the R, G and B signals are expected to have values close to the maximum density value. On the other hand, when the in-original black image is expressed by color pixels, the in-original black image is expected to have a tendency according to the characteristic of the entire original. Setting the coefficients α, β and γ corresponding to such characteristics is preferable in order to separate the out-of-original black image and other images highly accurately.

For example, if the density value of the R signal in the in-original black image tends to increase, the value of the coefficient α is set to a relatively smaller value than the coefficients β and γ. Thus, the BK value in the in-original black image becomes a smaller density value than the simple average value of the R, G and B signals. Consequently, it is easier to separate the in-original black image and the out-of-original black image.

The coefficients α, β and γ may also be set in accordance with information inputted by the user with the operation unit 14.

As the monochrome converting unit 41 of the out-of-original deleting unit 35 converts each pixel of the inputted color image to monochrome, the monochrome converting unit 41 then binarizes each monochrome pixel. The monochrome converting unit 41 binarizes the BK value by using a threshold value for separating the out-of-original black image and the images of the other areas. For example, the monochrome converting unit 41 converts a pixel having a BK value equal to or larger than the threshold value to “1”, and converts a pixel having a BK value less than the threshold value to “0”. In this case, the monochrome converting unit 41 determines that a pixel having a BK value equal to or larger than the threshold value is a pixel which is likely to be of the out-of-original black image, and that a pixel having a BK value less than the threshold value is a pixel which is likely to be of other images than the out-of-original black image.

The out-of-original detecting unit 42 of the out-of-original deleting unit 35 determines whether the pixel is an out-of-original pixel or not in accordance with the pixel value binarized by the monochrome converting unit 41. For example, in the above example, a pixel having a binarized value “1” is an out-of-original pixel and a pixel having a binarized value “0” is a non-out-of-original (in-original) pixel. In short, in this case, the out-of-original detecting unit 42 determines that a pixel having a binarized value “1” is out of the original and that a pixel having a binarized value “0” is within the original.

However, it is considered that the out-of-original black image is distributed around the in-original image. Therefore, the out-of-original detecting unit 42 may determine whether the position of each pixel (the area where the pixel exists) is likely to be out of the original or not. For example, if all the neighboring pixels are pixels within the original, the out-of-original detecting unit 42 may corrects the result of determination so as to determine that the pixel is within the original even if it has a value “1”.

When the out-of-original area is detected by the out-of-original detecting unit 42, the deleting unit 43 in the out-of-original deleting unit 35 carries out processing to delete the image of the out-of-original area from the inputted color image. The deleting unit 43 is provided with information indicating the out-of-original area from the out-of-original detecting unit 42 and is also supplied with the color image data inputted to the out-of-original deleting unit 35. That is, the deleting unit 43 deletes the image of the out-of-original area in the inputted color image data in accordance with the information indicating the out-of-original area provided from the out-of-original detecting unit 42. The deleting unit 43 outputs the color image data from which the out-of-original area is deleted.

Next, a flow of signals in the out-of-original deleting unit 35 will be described in detail.

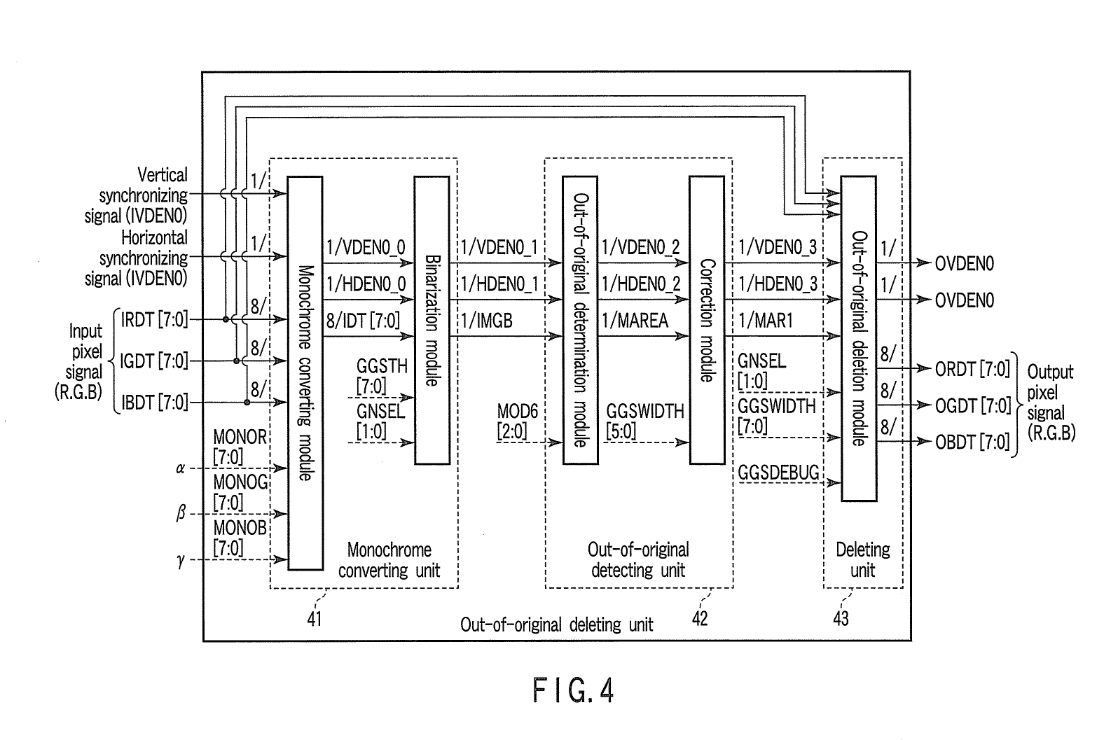

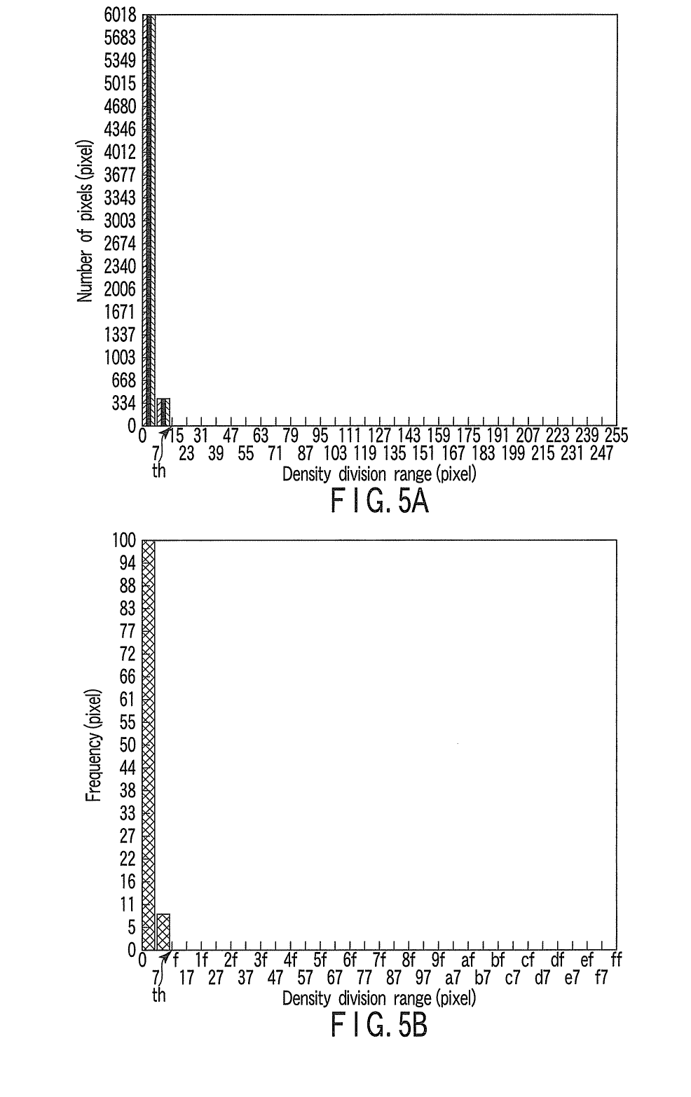

FIG. 4 is a view for explaining the flow of signals in the out-of-original deleting unit 35.

As shown in FIG. 4, input pixel signals (IRDT, IGDT, IBDT) are inputted to the out-of-original deleting unit 35, together with a vertical synchronizing signal (IVDEN) and a horizontal synchronizing signal (IHDEN). The input pixel signals (IRDT, IGDT, IBDT) are R, G and B signals of each color pixel in a color image such as an image scanned by the scanner 12. The input pixel signals are supplied to the monochrome converting unit 41 and the deleting unit 43 in the out-of-original deleting unit 35.

The monochrome converting unit 41 includes a monochrome conversion module and a binarization module. The input pixel signals (IRDT, IGDT, IBDT), a vertical synchronizing signal (IVDEN0) and a horizontal synchronizing signal (IHDEN0) are inputted to the monochrome conversion module. For example, the page memory control unit of the page memory 33 supplies the input pixel signals (IRDT, IGDT, IBDT) together with the vertical synchronizing signal (IVDEN0) and the horizontal synchronizing signal (IHDEN0) to the monochrome conversion module. Also, the values of coefficients α, β and γ (MONOR, MONOG, MONOB) for converting the three signals of R, G and B to monochrome are inputted to the monochrome conversion module. For example, the CPU 31 supplies the coefficients α, β and γ to the monochrome conversion module.

The monochrome conversion module multiplies the three signals (IRDT, IGDT, IBDT) as input pixel signals by the coefficients α, β and γ, respectively, and calculates the sum of the multiplied values. This calculated sum is a BK value (IDT) as a monochrome pixel value obtained by converting the input pixel signals to monochrome. The monochrome conversion module outputs the BK value (IDT) to the binarization module synchronously with the timing of a vertical synchronizing signal (IVDEN0_0) and a horizontal synchronizing signal (IHDEN0_0).

A threshold value (GGSTH) for binarizing the BK value (IDT) is inputted to the binarization module. For example, the CPU 31 supplies the threshold value (GGSTH) to the binarization module. The binarization module determines whether the BK value (IDT) is equal to or larger than the threshold value (GGSTH), or not. For example, the binarization module converts a BK value equal to or larger than the threshold value to “1” and converts a BK value less than the threshold value to “0”. That is, the binarization module converts each pixel of the inputted color image to a binarized pixel value (IMGB). The binarization module outputs the binarized pixel value (IMGB) to the out-of-original detecting unit 42 synchronously with the timing of a vertical synchronizing signal (IVDEN0_1) and a horizontal synchronizing signal (IHDEN0_1).

The out-of-original detecting unit 42 has an out-of-original determination module and a correction module. The binarized pixel value (IMGB) is inputted to the out-of-original determination module together with the vertical synchronizing signal (IVDEN0_1) and the horizontal synchronizing signal (IHDEN0_1). Here, it is assumed that the binarization module converts a pixel having a value equal to or larger than the threshold value to “1” and converts a pixel having a value less than the threshold value to “0”. In this case, the out-of-original determination module determines that a pixel having a binarized pixel value (IMGB) of “1” is out of the original and that a pixel having a binarized pixel value (IMGB) of “0” is within the original. The out-of-original determination module supplies information (MAREA) showing the result of the determination based the binarized pixel value (IMGB) to the correction module in timing indicated by a vertical synchronizing signal (IVDEN0_2) and a horizontal synchronizing signal (IHDEN0_2). The information (MAREA) showing the result of the determination is, for example, information indicating the position of a pixel determined as out of the original.

The information (MAREA) showing the result of the determination based on the binarized pixel value is supplied to the correction module synchronously with the vertical synchronizing signal (IVDEN0_2) and the horizontal synchronizing signal (IHDEN0_2). The correction module is adapted to correct the information (MAREA) showing the result of the determination. For example, the correction module confirms whether the position of the pixel determined as out of the original is in the out-of-original area or not.

When it is determined that the result of the determination (MAREA) by the out-of-original determination module is likely to be accurate in terms of position, the correction module outputs the information (MAREA) showing the result of the determination as a final determination result (MAR1). When it is determined that the result of the determination (MAREA) by the out-of-original determination module is unlikely to be accurate in terms of position, the correction module outputs a determination result obtained by correcting the information (MAREA) showing the result of the determination, as a final determination result (MAR1).

The information (MAR1) showing the final determination result on each pixel is supplied to the deleting unit 43 synchronously with a vertical synchronizing signal (IVDEN0_3) and a horizontal synchronizing signal (IHDEN0_3). Also, the input pixel signals (IRDT, IGDT, IBDT) as each pixel data of the color image inputted to the out-of-original deleting unit 35 are supplied to the deleting unit 43.

That is, to the deleting unit 43, the information (MAR1) showing whether the pixel is out of the original or not is supplied together with the input pixel signals (IRDT, IGDT, IBDT). However, the input pixel signals (IRDT, IGDT, IBDT) and the information (MAR1) showing the determination result, supplied to the deleting unit 43, corresponds to each other. For example, the input pixel signals (IRDT, IGDT, IBDT) are delayed by a delay circuit, not shown, and inputted to the deleting unit 43, corresponding to the information (MAR1) showing the determination result of the pixels.

The deleting unit 43 outputs the image data from which the out-of-original area is deleted, as output pixel signals (ORDT, OGDT, OBDT). That is, when the information (MAR1) showing the determination result indicates that the pixels are not out-of-original pixels, the deleting unit 43 directly outputs the input pixel signals (IRDT, IGDT, IBDT) as output pixel signals (ORDT, OGDT, OBDT). When the information (MAR1) showing the determination result indicates that the pixels are out-of-original pixels, the deleting unit 43 outputs pixel values that make all the R, G and B signals have the minimum density value (white pixel values), as output pixel signals (ORDT, OGDT, OBDT), in order to delete the image of these pixels (out-of-original black image).

Next, an exemplary histogram with respect to an out-of-original black image and an in-original black image will be explained.

FIG. 5A is a view showing an exemplary histogram with respect to an out-of-original black image. FIG. 5B is a view showing an exemplary histogram with respect to a pixel value obtained by converting each pixel in the out-of-original black image into monochrome. In FIG. 5A and FIG. 5B, for a pixel having a density value expressed by 0 to 255 (ff) gradation levels, the number of pixels or frequency is calculated within a density range of every eight gradation levels. In FIG. 5A and FIG. 5B, the smaller the density value is, the greater the density of the pixel is. In short, in FIG. 5A and FIG. 5B, the greatest density is shown on the left side.

FIG. 5A shows a histogram of an out-of-original black image before being processed by the out-of-original deleting unit 35. In FIG. 5A, the vertical axis represents the number of pixels. However, in this embodiment, it is assumed that an image to be processed is a color image. Therefore, FIG. 5A shows the number of pixels for each of R, G and B. FIG. 5B shows a histogram of each pixel in the out-of-original black image after being processed by the monochrome converting unit 41. In FIG. 5B, the vertical axis represents the appearance frequency of the pixel. As described above, the monochrome converting unit 41 multiplies each value of R, G and B of each pixel by a coefficient, then sums the resulting values and outputs the sum as a monochrome pixel value. Therefore, the frequency shown in FIG. 5B is equivalent to the appearance frequency of the pixel.

In the out-of-original black image, as described above, the density values of R, G and B colors usually are uniformly close to the maximum density value. Therefore, in the histogram shown in FIG. 5A, the numbers of pixels of R, G and B are substantially the same in the density ranges of 0 to 7 and 8 to 15. In short, each pixel constituting the out-of-original black image has substantially the same density value for R, G and B. This means that, in monochrome conversion by the monochrome converting unit 41, whatever coefficients (α, β, γ) are set, the histogram of image data converted to monochrome takes a shape similar to that of FIG. 5A, as shown in FIG. 5B. In such cases, for example, if the threshold value (th) is “15(f)”, an image having a histogram as shown in FIG. 5B is determined as an image in which most of pixels are out-of-original.

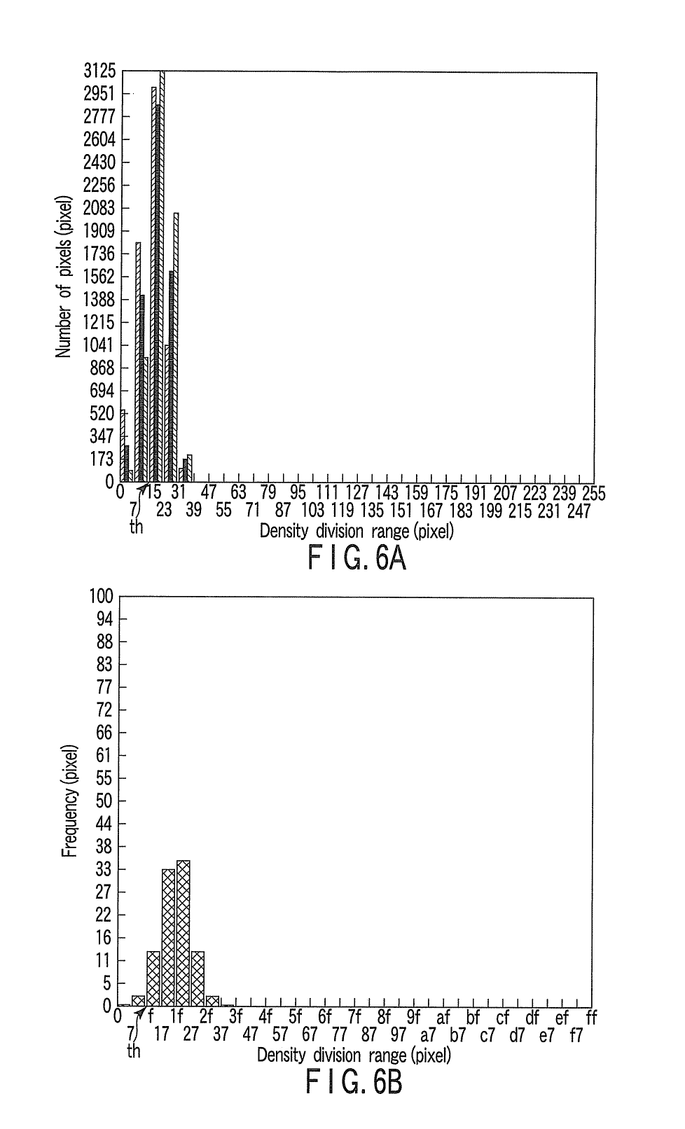

FIG. 6A is a view showing a histogram with respect to an in-original black image. FIG. 6B is a view showing a histogram with respect to a pixel value obtained by converting each pixel in the in-original black image to monochrome. In FIG. 6A and FIG. 6B, as in FIG. 5A and FIG. 5B, for a pixel having a density value expressed by 0 to 255 (ff) gradation, the number of pixels or frequency is shown in a density range of every eight gradation levels. In FIG. 6A and FIG. 6B, as in FIG. 5A and FIG. 5B, the smaller the density value is, the greater the density of the pixel is.

In each pixel in the in-original black image, R, G and B values are often uneven. In the histogram shown in FIG. 6A, the number of pixels of R, G and B are uneven in each density range. This means that many pixels have R, G and B values in different density ranges. Such pixels tend to be converted to pixel values with light density values through monochrome conversion by the monochrome converting unit 41. That is, compared with the out-of-original black image, the pixel values in the in-original black image have a stronger tendency to be converted to monochrome pixel values with light density values by monochrome conversion by the monochrome converting unit 41.

Therefore, the in-original black image having the histogram as shown in FIG. 6A is converted to image data having the histogram as shown in FIG. 6B by the monochrome converting unit 41. For example, if the threshold value (th) is “15(f)”, most pixels in the image having the histogram as shown in FIG. 6B are not determined as pixels of the out-of-original image (they are determined as pixels of the in-original image).

As described above, in monochrome conversion by the monochrome converting unit 41, each pixel in the out-of-original black image tends to be converted to a pixel value with a high density value, and each pixel in the in-original black image tends to be converted to a pixel value with a low density value. Thus, as the color image scanned by the scanner 12 is converted to monochrome by the monochrome converting unit 41, the out-of-original deleting unit 35 can easily separate the out-of-original black image and the in-original black image.

Next, a flow of copy processing including out-of-original deletion in the digital multifunction peripheral 1 will be outlined.

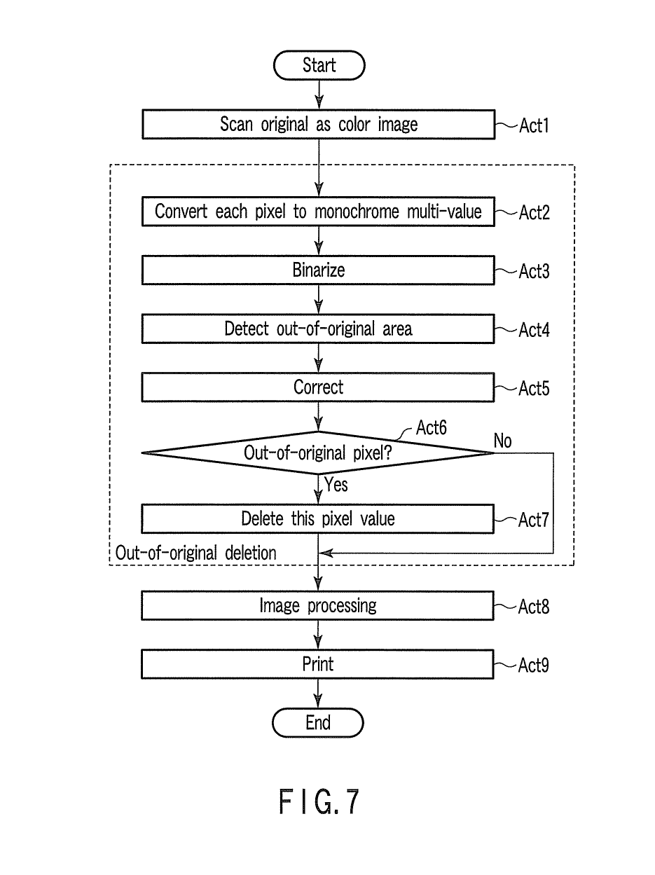

FIG. 7 is a flowchart for explaining the flow of copy processing including out-of-original deletion.

First, the scanner 12 optically scans an original on the platen glass as a color image, with the platen cover kept open (Act 1). The scanner 12 supplies the color image data of the scanned original to the main control unit 11. The main control unit 11 causes the out-of-original deleting unit 35 to delete an out-of-original area from the color image data scanned by the scanner 12 (Acts 2 to 7).

That is, the out-of-original deleting unit 35 converts each color pixel in the color image data scanned by the scanner 12 to monochrome by using the monochrome converting unit 41. The monochrome converting unit 41 converts each color pixel in the color image data to a multi-value monochrome density value (Act 2). For example, the monochrome converting unit 41 multiplies the R, G and B values by the coefficients α, β and γ, respectively, and sums the resulting values, thereby converting each color pixel to a multi-value monochrome density value. When each pixel is converted to a multi-value monochrome density value, the monochrome converting unit 41 binarizes the monochrome-converted multi-value monochrome density value (Act 3). The monochrome converting unit 41 binarizes the pixel having the multi-value monochrome density value in accordance with the threshold value to separate the out-of-original black image and other images.

In the out-of-original deleting unit 35, the value binarized by the monochrome converting unit 41 is supplied to the out-of-original detecting unit 42. The out-of-original detecting unit 42 determines whether the value binarized by the monochrome converting unit 41 is a value indicating an out-of-original pixel or not (Act 4). Moreover, the out-of-original detecting unit 42 confirms whether the position of the pixel determined as an out-of-original pixel is likely to be in the out-of-original area or not. The out-of-original detecting unit 42 corrects the determination result indicating whether each pixel is out of the original or not, in accordance with the result of the confirmation (Act 5). In the out-of-original deleting unit 35, the final determination result for each pixel made by the out-of-original detecting unit 42 is supplied to the deleting unit 43.

Each color pixel in the color image data is sequentially inputted to the deleting unit 43. When the inputted color pixel is an pixel determined as out-of-original by the out-of-original detecting unit 42 (YES in Act 6), the deleting unit 43 converts the color pixel to a white pixel value and outputs (deletes) this pixel (Act 7). When the inputted color pixel is a pixel determined as not out-of-original by the out-of-original detecting unit 42 (NO in Act 6), the deleting unit 43 outputs the color pixel with its value unchanged. As a result of such processing, the deleting unit 43 outputs image data from which the image of the out-of-original is deleted.

The out-of-original deleting unit 35 outputs the color image data from which the out-of-original pixels are deleted by the processing of Acts 2 to 7, to the image processing unit 34. The image processing unit 34 performs various image processing to form an image for printing from the color image data (Act 8). For example, the image processing unit 34 carries out color conversion, filtering, tone correction and so on. The image processed by the image processing unit 34 is outputted to the printer 13 as print image data. The printer 13 prints the color image data supplied from the image processing unit 34 onto a copy sheet (Act 9). By the series of processing as described above, the color image of the original set on the platen glass is printed (copied) onto a sheet.

As described above, in the digital multifunction peripheral of this embodiment, the out-of-original deleting unit converts color image data scanned by the scanner to monochrome image data, then detects an out-of-original area in the monochrome image data, and deletes the image of the area determined as out-of-original from the color image data scanned by the scanner. Thus, an out-of-original area can be detected highly accurately even in color image data scanned with the platen cover opened. Consequently, the digital multifunction peripheral can provide a color scanned image from which the out-of-original image is deleted highly accurately.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image scanning apparatus comprising:
a scanner that scans an image of an original as color image data;
a converting unit configured to convert the color image data scanned by the scanner into monochrome image data;
a detecting unit configured to detect an out-of-original area in the monochrome image data provided by the converting unit; and
a deleting unit configured to delete an image of the area determined as out-of-original by the detecting unit, in the color image data scanned by the scanner.

2. The apparatus according to claim 1, wherein the scanner scans the image of the original as color image data including a color pixel expressed by plural color values,
the converting unit converts each color pixel constituting the color image data to a monochrome pixel value, and
the detecting unit determines whether the monochrome pixel value provided by the converting unit is a value of an out-of-original pixel or not.

3. The apparatus according to claim 2, wherein the deleting unit converts a color pixel in the color image data corresponding to a pixel determined as out-of-original, to a white pixel value.

4. The apparatus according to claim 2, wherein the converting unit multiplies each of the plural color values expressing each color pixel by a coefficient and sums the resulting values to calculate a monochrome pixel value.

5. The apparatus according to claim 4, further comprising an operation unit for a user to input information,
wherein the converting unit sets a coefficient by which each color value is multiplied, in accordance with the information inputted from the operation unit.

6. The apparatus according to claim 2, wherein the converting unit further binarizes the monochrome pixel value by using a threshold value for separating an out-of-original pixel and other pixels.

7. The apparatus according to claim 6, further comprising an operation unit for a user to input information,
wherein the converting unit sets the threshold value in accordance with the information inputted from the operation unit.

8. A copying apparatus comprising:
a scanner that scans an image of an original as color image data;
a converting unit configured to convert the color image data scanned by the scanner into monochrome image data;
a detecting unit configured to detect an out-of-original area in the monochrome image data provided by the converting unit;
a deleting unit configured to delete an image of the area determined as out-of-original by the detecting unit, in the color image data scanned by the scanner; and
a printer that prints the image from which the image of the out-of-original area is deleted by the deleting unit, onto a recording medium.

9. The apparatus according to claim 8, wherein the scanner scans the image of the original as color image data including a color pixel expressed by plural color values,
the converting unit converts each color pixel constituting the color image data to a monochrome pixel value, and
the detecting unit determines whether the monochrome pixel value provided by the converting unit is a value of an out-of-original pixel or not.

10. The apparatus according to claim 9, wherein the deleting unit converts a color pixel in the color image data corresponding to a pixel determined as out-of-original, to a white pixel value.

11. The apparatus according to claim 9, wherein the converting unit multiplies each of the plural color values expressing each color pixel by a coefficient and sums the resulting values to calculate a monochrome pixel value.

12. The apparatus according to claim 11, further comprising an operation unit for a user to input information,
wherein the converting unit sets a coefficient by which each color value is multiplied, in accordance with the information inputted from the operation unit.

13. The apparatus according to claim 9, wherein the converting unit further binarizes the monochrome pixel value by using a threshold value for separating an out-of-original pixel and other pixels.

14. The apparatus according to claim 13, further comprising an operation unit for a user to input information,
wherein the converting unit sets the threshold value in accordance with the information inputted from the operation unit.

15. An image scanning method comprising:
scanning an image of an original as color image data;
converting the scanned color image data into monochrome image data;
detecting an out-of-original area in the monochrome image data provided by the conversion; and
deleting an image of the area determined as out-of-original by the detection, in the scanned color image data.

16. The method according to claim 15, wherein in the scanning, the image of the original is scanned as color image data including a color pixel expressed by plural color values,
in the converting, each color pixel constituting the color image data is converted to a monochrome pixel value, and
in the detecting, it is determined whether the monochrome pixel value provided by the converting is a value of an out-of-original pixel or not.

17. The method according to claim 16, wherein in the deletion, a color pixel in the color image data corresponding to a pixel determined as out-of-original is converted to a white pixel value.

18. The method according to claim 16, wherein in the converting, each of the plural color values expressing each color pixel is multiplied by a coefficient and the resulting values are summed to calculate a monochrome pixel value.

19. The method according to claim 18, wherein in the converting, a coefficient by which each color value is multiplied is set in accordance with information inputted by a user.

20. The method according to claim 16, wherein further in the converting, the monochrome pixel value is binarized by using a threshold value for separating an out-of-original pixel and other pixels.

21. The method according to claim 20, wherein in the converting, the threshold value is set in accordance with the information inputted by the user.
